(19) United States
(12) Patent Application Publication
(10) Pub. No.: US 2023/0012982 A1
(43) Pub. Date: Jan. 19, 2023

(54) A REDUNDANT BRAKE DEVICE SYSTEM

(71) Applicant: VOLVO TRUCK CORPORATION, Göteborg (SE)

(72) Inventors: Leo LAINE, Härryda (SE); Leon HENDERSON, Härryda (SE); Christian OSCARSSON, Stenungsund (SE); Edo DRENTH, Helsingborg (SE); Kristoffer NILSSON, Lund (SE)

(73) Assignee: VOLVO TRUCK CORPORATION, Göteborg (SE)

(21) Appl. No.: 17/757,024

(22) PCT Filed: Dec. 10, 2019
(86) PCT No.: PCT/EP2019/084362

§ 371 Date: Jun. 8, 2022

(51) Int. Cl. B60T 8/17; B60T 8/18; B60T 8/32; B60T 8/88

(52) U.S. Cl. CPC B60T 8/1708; B60T 8/1881; B60T 8/323; B60T 8/329; B60T 8/885; B60T 2270/402; B60T 2270/413

(57) ABSTRACT

A braking system for a heavy duty vehicle includes a first brake controller arranged to control braking on a front axle left wheel, and a second brake controller arranged to control braking on a front axle right wheel. The first and second brake controllers are connected by a back-up connection arranged to allow one of the first and the second brake controller to assume braking control of the wheel of the other of the first and the second brake controller. The first and second brake controllers are arranged as fail-operational brake controllers. A third brake controller is arranged to control braking on a first rear axle left wheel, and a fourth brake controller is arranged to control braking on a first rear axle right wheel. The third and the fourth brake controllers are arranged to place respective rear axle left and right wheels in an unbraked state in response to failure. The third and fourth brake controllers are arranged as fail-silent brake controllers.

### TECHNICAL FIELD

The present disclosure relates to redundancy in braking systems for heavy duty vehicles. The disclosure is particularly relevant to vehicles configured for autonomous drive. The invention can be applied in heavy-duty vehicles, such as trucks and construction equipment. Although the invention will be described mainly with respect to cargo transport vehicles such as semi-trailer vehicles and trucks, the invention is not restricted to this particular type of vehicle but may also be used in other types of vehicles such as cars.

### BACKGROUND

The braking system of a heavy duty vehicle is key to safe vehicle operation. The braking system not only limits vehicle velocity when needed, but also plays an important role in maintaining vehicle stability. A heavy duty vehicle with a malfunctioning brake system therefore represents a significant risk. It is desired to minimize this risk.

To ensure that the vehicle does not lose braking capability, or becomes unstable due to a malfunctioning braking system, redundancy may be added to the braking system. Redundancy may be added both the control system as well as to the actuators, e.g., the disc or drum brakes.

In order to achieve redundancy in the vehicle braking system, a brake system layout that includes two or more independently controlled complete brake systems that are either arranged in parallel or in series is commonly used. Thus, if one system fails, a back-up system is available to assume control and operate the vehicle brakes. However, this type of redundancy drives overall vehicle cost and complicates vehicle assembly.

US 2017/0210361 A1 discloses a brake controller layout for a heavy-duty vehicle comprising redundancy. However, there is a continuing need for further improvements in braking systems for heavy duty vehicles.

### SUMMARY

It is an object of the present disclosure to provide improved braking systems. This object is at least in part obtained by a braking system for a heavy duty vehicle. The braking system comprises a first brake controller arranged to control braking on a front axle left wheel, and a second brake controller arranged to control braking on a front axle right wheel. The first and the second brake controllers are connected by a back-up connection arranged to allow one of the first and the second brake controller to assume braking control of the wheel of the other of the first and the second brake controller, whereby the first and second brake controllers are arranged as fail-operational brake controllers. The braking system further comprises a third brake controller arranged to control braking on a first rear axle left wheel, and a fourth brake controller arranged to control braking on a first rear axle right wheel, wherein the third and the fourth brake controllers are arranged to place respective rear axle left and right wheels in an unbraked state in response to brake controller failure, whereby the third and fourth brake controllers are arranged as fail-silent brake controllers.

This way the front axle wheels are arranged with brake controller redundancy even though there is only one brake controller arranged per wheel, which is an advantage. The front axle wheels are fail operational, meaning that both wheels can be braked despite one or the brake controllers failing, which is a further advantage. The rear axle wheel brake controller are fail silent, meaning that a brake controller failure will not prevent the vehicle from operating. It has been realized that overall vehicle safety is not overly affected by a rear axle controller failure, at least partly since tyre normal force is transferred towards the front axle wheels during braking. The disclosed braking system provides sufficient vehicle brake redundancy to ensure vehicle safety, while at the same time enabling a cost efficient solution and ease of assembly.

Other aspects of the disclosed braking systems comprise fail-operational brake controller arrangements also on a rear axle or on rear axles of the vehicle. These fail-operational rear axle controllers may be arranged in fail-operational pairs on a common vehicle axle where right and left wheel brake controllers are connected by a back-up connection, or on a common vehicle side where first and second rear axle brake controllers on one side of the vehicle are connected by a back-up connection allowing each of the controllers to assume control of the wheel of the other controller in case of brake controller failure.

According to aspects, the braking system further comprises a fifth brake controller arranged to control braking on a second rear axle left wheel, and a sixth brake controller arranged to control braking on a second rear axle right wheel, wherein the fifth and the sixth brake controllers are arranged to place respective second rear axle left and right wheels in an unbraked state in response to failure, whereby the fifth and sixth brake controllers are arranged as fail-silent brake controllers. Thus, the fifth and sixth brake controllers are fail silent and associated with the same advantages as mentioned above in connection to the third and fourth brake controllers.

According to aspects, the braking system comprises a control unit arranged to control the braking system via at least a first data bus and a second data bus separate from the first data bus, wherein the first data bus is arranged to control at least the first brake controller and the fourth brake controller, and the second data bus is arranged to control at least the second brake controller and the third brake controller. Thus, in case one data bus fails, braking ability on both sides of the vehicle is maintained on at least one of the front and rear axle, which allows the vehicle to perform an emergency maneuver such as, e.g., an emergency stop. A vehicle control unit may be able to distribute brake force between functional brake controllers to maintain vehicle stability.

According to aspects, a failing rear axle wheel brake arranged as a fail-silent brake controller is configured to transmit a message to a vehicle control unit indicating a lack of braking capability. This way the vehicle control unit receives information of the reduced braking capability of the vehicle, and can act accordingly. For instance, depending on scenario, an emergency maneuver may be initiated where brake force allocation has been made in dependence of the lack of braking capability of the failed brake controller.

According to aspects, the failing rear axle wheel brake arranged as fail-silent brake controller is configured to be locked in a zero braking capability mode upon failure and until restart of the brake controller. This increases system robustness and overall vehicle safety. The controller itself might be dead and not able to actively respond with a zero capability message in response to polling or the like. The data bus may be configured to lock the capability value of the failed brake controller, with no possibility to unlock it until controller restart.

According to aspects, the braking system comprises a respective back-up electrical energy source arranged to allow transmission of the message to the vehicle control unit in the event of failure. Thus, in case a brake controller loses its main power supply, it will still be able to transmit the failure status message using the back-up electrical energy source. The back-up source may, e.g., be a rechargeable battery or the like which can be easily assembled and also replaced when needed.

According to aspects, each front axle wheel brake controller is connected to a respective first wheel speed sensor and to a respective second wheel speed sensor, thereby providing wheel speed sensor redundancy at the front axle. This increases system robustness, since at least one front axle wheel speed sensor may fail without it affecting overall system operation.

According to aspects, a wheel speed sensor associated with a wheel on the front axle is arranged connected to a brake controller associated with a wheel on the other side of the front axle. This cross-wise connection provides a level of redundancy which may be particularly useful when the back-up connection is active, since the master brake controller that is controlling both wheels then has access to wheel speeds of both wheels. Also, the vehicle control unit may use the wheel speeds from both wheels to determine brake force allocation and the like.

According to aspects, the vehicle comprises first and second rear wheel axles, wherein a wheel speed sensor associated with a wheel on the first rear axle is arranged connected to a brake controller associated with a wheel on the second rear wheel axle and on the same side as the wheel on the first rear axle. This way, if a rear axle wheel speed sensor fails, both brake controllers on that side of the vehicle still has access to wheel speed data associated with the correct vehicle side.

According to aspects, the vehicle comprises a trailer unit supported on a set of trailer wheels, wherein at least one of the wheels in the set of wheels comprises a brake controller arranged in fail silent mode. Thus, the advantages discussed above also apply to semi-trailer type vehicles.

According to aspects, a rear axle wheel brake controller is arranged to detect wheel lift-off by comparing wheel speed sensor output from respective first rear axle wheel speed sensor and second rear axle wheel speed sensor. By comparing the wheel speeds from rear wheels on one side of the vehicle, vehicle lift-off can be detected. The detection may, e.g., be based on wheel speed differences.

According to aspects, the control unit is arranged to re-allocate braking force in response to brake controller failure. Thus, vehicle braking need not be overly affected by the brake control failure, since other brake controllers may assume part of the braking that the failed controller was originally tasked with.

According to aspects, the control unit is arranged to re-evaluate vehicle stability in response to brake controller failure. This means that vehicle stability can be improved, which is an advantage.

There is also disclosed herein control units, computer programs, computer readable media, computer program products, and vehicles associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIGS. 1A-C schematically illustrate some example heavy duty vehicles;

FIGS. 2-3 show example interconnected front axle brake controllers;

FIG. 4 illustrates an example tractor brake device layout;

FIGS. 5A-B show example interconnected rear axle brake controllers;

FIG. 6 illustrates an example trailer brake device layout;

FIGS. 7-8 schematically show example brake controller arrangements;

FIG. 9 is a flow chart illustrating methods;

FIG. 10 schematically illustrates a control unit; and

FIG. 11 shows an example computer program product.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

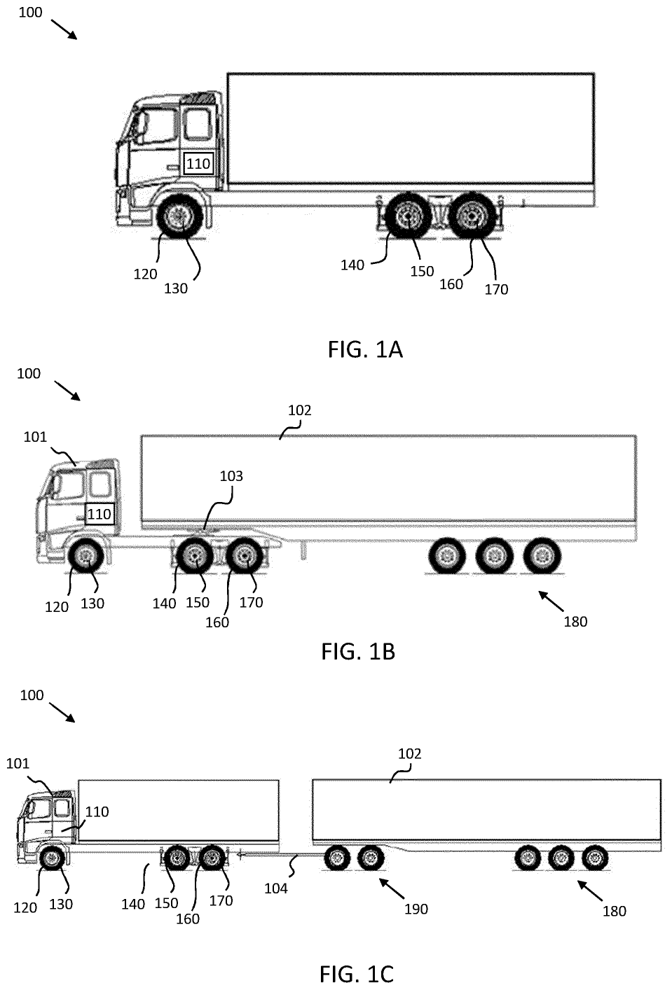

FIGS. 1A-C illustrates a number of example vehicles 100 for cargo transport. FIG. 1A shows a truck supported on wheels 120, 140, and 160, some of which are driven wheels.

FIG. 1B shows a semitrailer vehicle where a tractor unit 101 tows a trailer unit 102. The front part of the trailer unit 102 is supported by a fifth wheel connection 103, while the rear part of the trailer unit 102 is supported on a set of trailer wheels 180.

FIG. 1C shows a truck with a dolly unit 104 arranged to tow a trailer unit 102. The front part of the trailer unit is then supported on a set of dolly wheels 190, while the rear part of the trailer is supported on a set of trailer wheels 180.

Each vehicle 100 comprises a control unit 110. This control unit may potentially comprise a number of sub-units distributed across the vehicle, or it can be a single physical unit. The control unit controls vehicle operation. The control unit 110 may, e.g. allocate brake force between wheels to maintain vehicle stability. Each of the wheel brake controllers is communicatively coupled to the control unit 110, allowing the control unit to communicate with the brake controllers, and thereby control vehicle braking.

Vehicle combinations such as those discussed above are known in general and will not be discussed in more detail herein. The techniques disclosed herein are applicable to a wide range of different vehicle combinations and vehicle types, not just to the combinations shown in FIGS. 1A-1C. It is furthermore appreciated that the techniques disclosed herein are also applicable to, e.g., an electrically powered vehicles or a hybrid electric vehicles.

Each wheel is associated with a wheel brake 130, 150, 160 (trailer unit wheel brakes are not indicated in FIGS. 1A-1C). This wheel brake may, e.g., be a pneumatically actuated disc brake or drum brake, but some aspects of the disclosure are also applicable for regenerative brakes which produce electrical power during vehicle retardation, as well as to electrically powered disk or drum brakes, such as Electro Mechanical Brakes (EMB).

The wheel brakes are controlled by brake controllers. Herein, the terms brake controller, brake modulator, and wheel end module will be used interchangeably. They are all to be interpreted as a device which controls applied braking force on at least one wheel of a vehicle, such as the vehicle 100. A service brake system is a system which brakes the vehicle during drive operation, as opposed to a parking brake system which is configured to keep the vehicle in a fixed position when parked.

For the brake system it is desirable that, in the event of a single electrical failure, no or limited loss of braking performance (maximum deceleration capability) and no or limited loss of vehicle stability occurs. Most known service brake systems can only fulfil this requirement if two service brake systems are installed in parallel, resulting in a doubling of parts, piping and air fittings.

Recent development in service brake systems, however, comprises an arrangement that instead includes individual brake controllers at each wheel of the vehicle. In normal operation each brake controller is responsible for controlling the brake force, regulating wheel slip, preventing wheel locking and carrying out diagnostics on a respective wheel of the controller. However, in addition to this, a control output of each controller can also be connected to a ‘back-up’ port on one of the other brake controllers. This way a controller can assume the function of a faulty controller by operating its connection to the back-up port of the faulty controller. The connection to the back-up port may be a pneumatic connection engageable by one or more control valves. The faulty controller then only needs to open up access between the back-up port and the brake actuator in order to allow an external controller to control wheel braking by the actuator of the failed controller. According to some aspects, the default state of a controller is a state comprising access between the back-up port and the brake actuator. Thus, if the brake controller suffers power outage or otherwise fails for some reason, access between back-up port and brake controller is automatically opened.

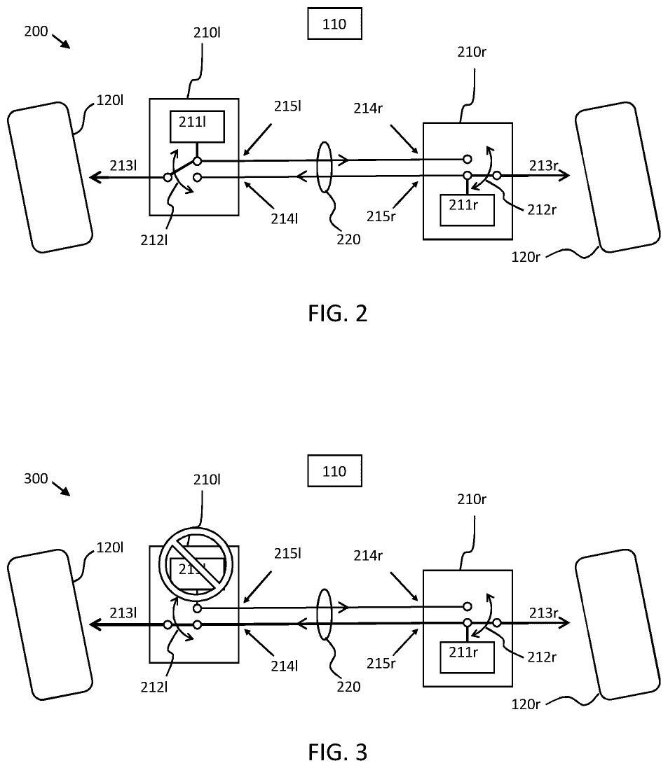

FIG. 2 schematically illustrates a set-up like this; a left wheel end module (VVEM) 210l is arranged to control braking of a left front axle wheel 120l via a control connection 213l. The control connection may, e.g., be a pneumatic connection for actuating a disc brake or the like. A right WEM 210r is arranged to control braking of a right front axle wheel 120r via a similar control connection 213r.

The two WEMs are linked by a back-up connection 220, allowing each WEM to assume control of the braking of the other wheel. Thus, if one of the WEMs fail the other can take over in order to maintain vehicle braking capacity, effectively providing brake control redundancy.

Each WEM 210l, 210r comprises means 211l, 211r for generating braking force on its respective wheel. In a default mode (shown in FIG. 2), where both WEMs 210l, 210r are fully functional and operation as intended, the back-up ports 214l, 214r are disconnected from the respective wheel brake by switches 212l, 212r. These ‘switches’ may, e.g., be pneumatic valves in case the back-up connection 220 is a pneumatic connection. If a WEM 210l, 210r fails, it flips its respective switch 212l, 212r such that the other WEM can assume control via the control connection 220. The change in mode from an active mode where the controller is in control of the brake to a slave mode where the controller passes control to the other controller may be automatically triggered by, e.g., loss of electrical power or the like.

When one front axle WMM 210l, 210r fails, it may therefore use the other (still functional) WEM for brake control. The switch 212l, 212r may be operated automatically upon WEM failure, or it may be operated remotely from the control unit 110. In case the switch is a pneumatic valve, the valve may, e.g., be default open and/or remotely controllable from the control unit 110, i.e., if the brake controller dies, the valve automatically opens (either on its own or by external control signal) to allow control by the other brake controller.

The control unit 110 may implement a polling function and/or a watchdog function in order to detect failed WEMs. A watchdog function is a timer which must be continuously reset by the module that is being watched. If the timer expires it means that the module has not reset it, i.e., the module is not fully functional and potentially dead. A polling function may comprise the control unit 110 periodically requesting a status message from each WEM. A failed WEM may respond back with a status indicating failure. A WEM which is totally dead will not respond at all, from which lack of response the control unit 110 can infer that the WEM has suffered failure and take appropriate action in response to the failure.

FIG. 3 schematically illustrates a scenario 300 where the left front axle controller 210l has failed. If, for instance, the left wheel 120l brake controller 210l suffers an electrical fault it will automatically fail to a state that passes the pneumatic pressure applied to its back-up port 214l, such that the back-up connection 220 is connected to the control connection 213l. Both wheels 120l, 120r will therefore now be controlled by the right hand brake controller 210r as shown in FIG. 3, with the failed controller 210l acting as a slave, making the overall system 200 fail-operational.

The two WEMs 211l, 211r on the front axle together constitute a fail-operational system, meaning that one controller may fail without the vehicle losing braking capability on any of the front axle wheels.

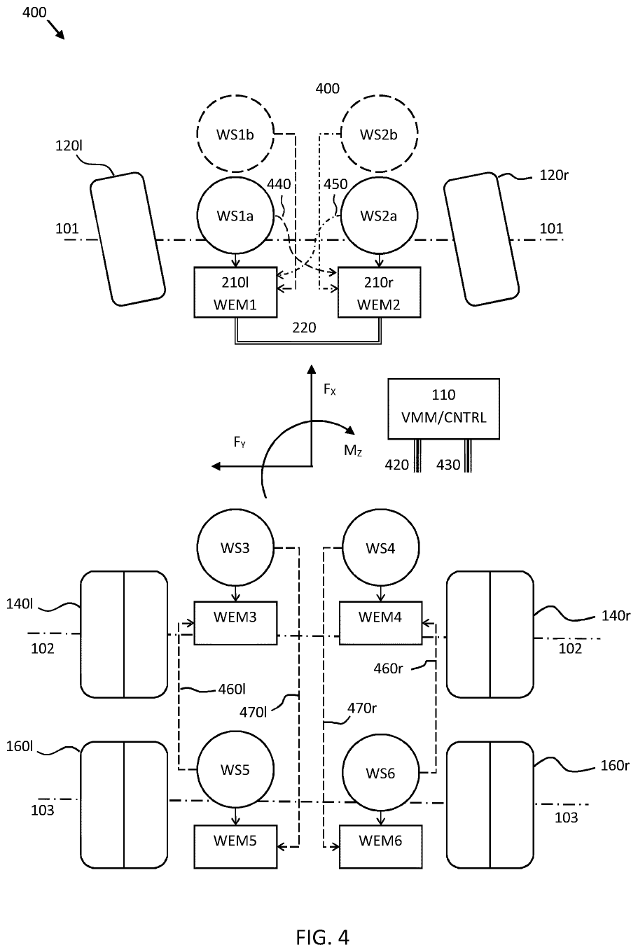

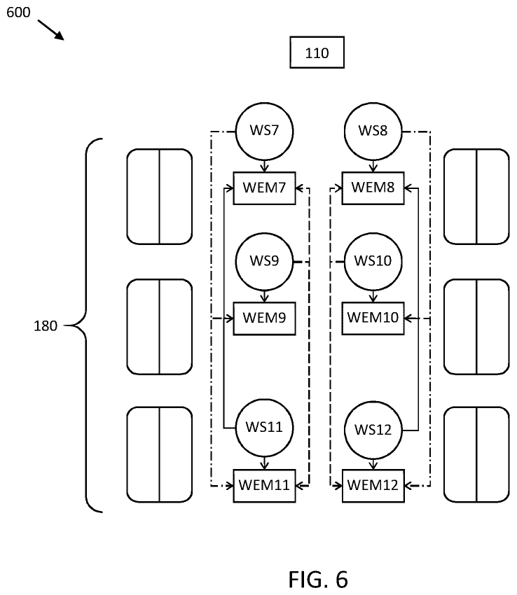

FIG. 4 shows a brake device system 400 layout according to the present teaching. There are two front axle wheels 120l, 120r, and four rear axle wheels 140l, 160l, 140r, 160r. It is appreciated that the principles of the present brake system can be applied to any number of rear axles, including towed vehicle units, dollies, and the like. A trailer unit brake system will be discussed below in connection to FIG. 6.

Each wheel has a corresponding WEM, numbered from 1 to 6 in FIG. 4. Each wheel also has at least one associated wheel speed sensor (WS), numbered from 1 to 6 in FIG. 4, where redundant sensors are denoted ‘a’ and ‘b’. Wheel speed sensors and their use for vehicle control is known and will not be discussed in more detail herein.

A vehicle motion management module (VMM) or control unit 110 controls at least part of the vehicle braking functionality. As noted above, the VMM may not only use the braking system for deceleration of the vehicle 100, but also for controlling vehicle stability as it maneuvers. The VMM 110 is connected by Controller Area Network (CAN) or Ethernet with dual channeling; a first communication bus 420 is connected to WEM1, WEM4, and WEM6 while a second bus 430 is connected to WEM2, WEM3, and WEM5. This has the effect of maintaining at least some braking capability on each side of the vehicle if one bus fails. In other words, the braking system 400 shown in FIG. 4 comprises a control unit 110, or Vehicle Motion Management unit (VMM) arranged to control the braking system 400 via at least a first data bus 420 and a second data bus 430, where the second data bus is arranged separate from the first data bus. The first data bus 420 is arranged to control at least the first brake controller WEM1 and the fourth brake controller WEM4, and the second data bus 430 is arranged to control at least the second brake controller WEM2 and the third brake controller WEM3. Thus, WEMs are connected on separate buses to assure that braking capability on both left and right sides of the vehicle is available if any of the communication busses 420, 430 fails. According to other aspects, each bus is connected to each brake controller, in a redundant fashion. This way a communication bus may go down without it affecting vehicle operation, since the back-up bus may be used instead.

According to other aspects, each WEM is connected to the control unit 110 or VMM by two or more redundant communication channels, i.e., the communication between VMM and each WEM is protected by redundancy.

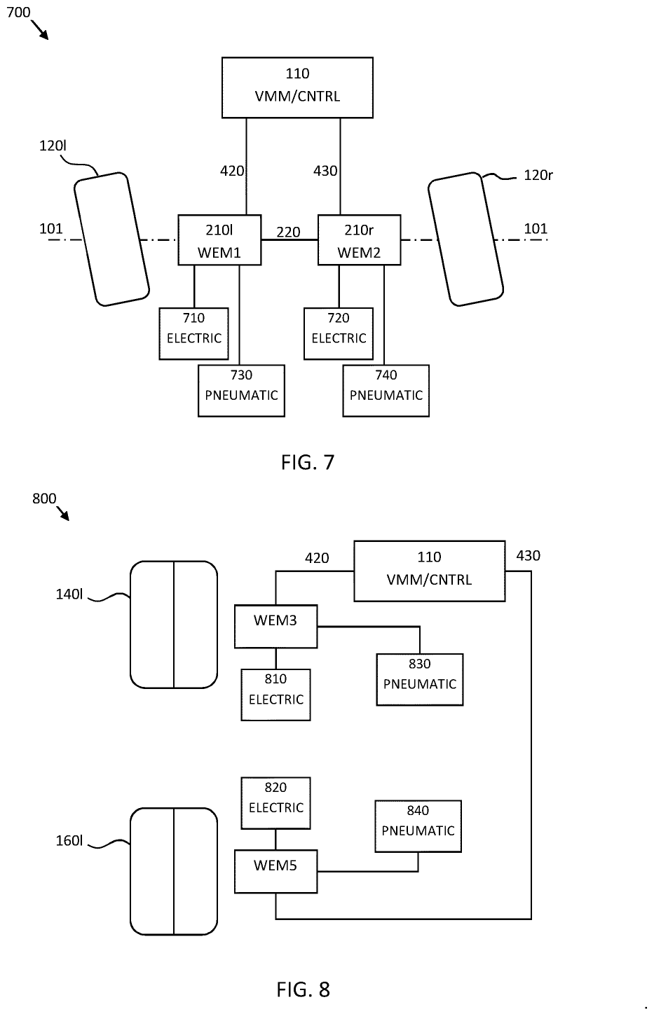

According to further aspects, each WEM is powered by at least two separate power sources and/or pneumatic sources, which means that a WEM can experience power source failure and/or pneumatic source outage without effect on its operation. Thus, the brake systems disclosed herein may comprise redundant power routing to provide redundant power supply to at least some of the brake controllers. Other forms of redundant power supplies and pneumatic supplies are discussed in more detail below in connection to FIG. 7 and FIG. 8.

Front axle WEMs 210l, 210r are arranged to be fail operational. Herein, ‘fail operational’ means that one controller may fail without the vehicle losing significant braking capability, since the other controller will take over via the back-up connection 220. Also, vehicle stability will likely not be critically affected since braking capability on the front axle wheels is substantially maintained. A failed WEM on the front axle will set the switch 212l, 212r (not shown in FIG. 4) to open stage and the still functioning WEM on the front axle takes control of the other wheel also.

Each wheel 120l, 120r on the front axle has an associated wheel speed sensor WS1a, WS2a. The data from the wheel speed sensor may be used to control braking in a known manner. The front axle may also be equipped with optional redundant wheel speed sensors WS1b, WS2b, which can be used in case one of the wheel speed sensors fail. As an alternative or as a complement to the redundant wheel speed sensors, cross-connections 440, 450 between one or more wheel speed sensors on one side of the vehicle may be connected to the brake controller on the other side of the vehicle. The cross-connections may be used to detect wheel speed for a wheel where the brake controller has failed. This way the still functional brake controller is able to obtain wheel speed data from both wheels, which may simplify brake control.

Rear axle WEMs, i.e., WEM 3, WEM 4, WEM 5, WEM 6 in FIG. 4, are according to some examples arranged to be fail silent. Herein, ‘fail silent’ means that one controller may fail without any back-up controller stepping in to maintain braking capability on the corresponding wheel. The wheel of the failed controller then effectively becomes an unbraked free-running wheel. A failing rear axle 102, 103 wheel brake controller WEM3, WEM4, WEM5, WEM6 arranged as a fail-silent brake controller may according to some aspects be configured to transmit a message to the vehicle control unit 110 indicating a lack of braking capability. The failing rear axle wheel brake controller WEM3, WEM4, WEM5, WEM6 arranged as fail-silent brake controller is then optionally locked in a zero braking capability mode until restart of the brake controller. This means that the failed brake controller cannot be used by the system until the vehicle has been stopped and rebooted. The brake controller may become totally dead and unresponsive. The communication bus, e.g., the CAN bus, may then be configured to provide the zero capability message in case a brake controller experiences failure and cannot report brake capability to, e.g., the control unit 110.

Each rear axle wheel brake controller WEM3, WEM4, WEM5, WEM6 may furthermore comprise a respective back-up electrical energy source, e.g., a battery, redundant power media, or the like, arranged to allow transmission of the message to the vehicle control unit 110 in the event of failure. This increases the likelihood of the control unit 110 receiving the information about the failed rear axle brake controller. Of course, the two front axle brake controllers may also be arranged to transmit warning messages about failure and the like to the control unit 110.

Thus, to summarize, FIG. 4 shows a braking system 400 for a heavy duty vehicle 100. The braking system comprises a first brake controller WEM1 arranged to control braking on a front axle 101 left wheel 120l, and a second brake controller WEM2 arranged to control braking on a front axle 101 right wheel 120r. The first and second brake controllers are connected by the back-up connection 220 that was discussed above in connection to FIGS. 2 and 3. The back-up connection is arranged to allow the first or the second brake controller to assume braking control of the wheel of the other of the first and the second brake controller, whereby the first and second brake controllers are arranged as fail-operational brake controllers. Thus, if the left brake controller WEM1 fails, the right brake controller WEM2 can take over via the back-up connection 220, and vice versa. The braking system 400 further comprises a third brake controller WEM3 arranged to control braking on a first rear axle 102 left wheel 140l, and a fourth brake controller WEM4 arranged to control braking on a first rear axle 102 right wheel 140r. The third and the fourth brake controllers are arranged to place respective rear axle left and right wheels in an unbraked state in response to failure, i.e. the third and fourth brake controllers are arranged as fail-silent brake controllers.

As also shown in FIG. 4, the braking system optionally also comprise a fifth brake controller WEM5 arranged to control braking on a second rear axle 103 left wheel 160l, and a sixth brake controller WEM6 arranged to control braking on a second rear axle 103 right wheel 160r. The fifth and the sixth brake controllers are arranged to place respective second rear axle left 160l and right 160r wheels in an unbraked state in response to failure, i.e., the fifth and sixth brake controllers are also arranged as fail-silent brake controllers.

According to some aspects, the WEM software has electrical backup storage enough to send a final message that braking capabilities are zero and that failure has been detected. This remains as the last known capability of zero torque. The VMM 110 can now re-allocate between the 5 of 6 available WEMs to achieve longitudinal braking. The available 5 WEMs provide the VMM with an opportunity to manage yaw control without a full redundancy comprising dual WEMs at wheel end. In the example of FIG. 4, total braking longitudinal force is ⅚ after one rear axle WEM has failed. In fact, the loss of braking capability is even smaller due to pitching during hard braking, i.e. wheel normal forces are reduced on rear axle and translated over to the wheels on the front axle. Similarly, total braking longitudinal force is ¾ in the 4×2 case. The zero capability of a failed rear axle controller is, according to some aspects, not possible to remove before full restart and re-boot of the system to see if the failed WEM actually can operate again after full stop has been conducted with the failed WEM.

According to aspects, each front axle 101 wheel brake controller WEM1, WEM2 is connected to a respective first wheel speed sensor WS1a, WS1b and to a respective second wheel speed sensor WS2a, WS2b. thereby providing wheel speed sensor redundancy at the front axle. The wheel speed sensors at the front axle 101 may optionally also be cross-linked, i.e., a wheel speed sensor WS1a, WS2a associated with a wheel 120l, 120r on the front axle 101 may be arranged connected to 440, 450 to a brake controller WEM1, WEM2 associated with a wheel 120l, 120r on the other side of the front axle.

According to some aspects, wheel speed sensors on the rear axle wheel are not duplicated. Instead of dual wheel speed sensors on the rear axles the WEMs on one side share the wheel speeds sensors for redundancy, as shown in FIG. 4 by connections 460l, 460r, 470l, 470r. This way at least hard braking can be made even with a failed wheel speed sensor on a rear axle wheel.

Thus, optionally, the vehicle comprises first 102 and second 103 rear wheel axles. A wheel speed sensor WS3, WS4 associated with a wheel 140l, 140r on the first rear axle 102 is arranged connected to 460l, 470r, 460l, 470r a brake controller WEM5, WEM6 associated with a wheel 160l, 160r on the second rear wheel axle 103 and on the same side as the wheel on the first rear axle 102.

An advantage with connecting wheel speed sensors on different rear axles to a brake controller is that the brake controller can compare the different wheel speeds and thereby detect, e.g., wheel lift-off conditions and the like. This detection may be communicated to the control unit 110.

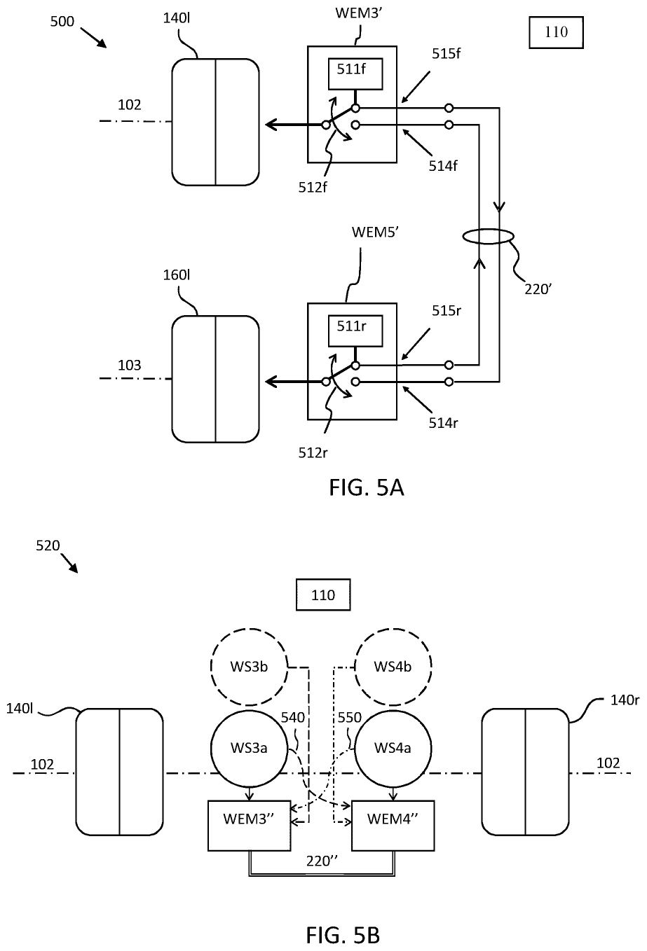

FIG. 5A shows another example brake controller layout 500 where rear axle WEMs are arranged in fail-operational mode instead of fail-silent mode as in FIG. 4. This means that one rear axle WEM may assume control of another rear axle WEM on the same side on the vehicle. Braking on the first rear axle left wheel 140l is controlled by WEM3′, while braking on the second rear axle left wheel 160l is controlled by WEM5′. Each WEM comprises means 511f, 511r for generating braking force on its respective wheel. In a default mode, where both WEMs are fully functional and operation as intended, the back-up ports 514f, 514r are disconnected from the respective wheel brake by switches 512f, 512r. These ‘switches’ may, e.g., be pneumatic valves in case the back-up connection 220′ is a pneumatic connection. If a WEM fails, it flips its respective switch 512f, 512r such that the other WEM can assume control via the control connection 220′. The change in mode from an active mode where the controller is in control of the brake to a slave mode where the controller passes control to the other controller may be automatically triggered by, e.g., loss of electrical power or the like.

The front axle brake controller arrangement from FIG. 4 can be used together with the rear axle brake controller arrangement 500 shown in FIG. 5A. The two WEMs in FIG. 5A correspond in function to the WEMs exemplified in FIGS. 2 and 3.

Thus, FIG. 5A shows a rear axle part 500 of a braking system for a heavy duty vehicle 100. The braking system comprises a first brake controller WEM1 arranged to control braking on a front axle 101 left wheel 120l, and a second brake controller WEM2 arranged to control braking on a front axle 101 right wheel 120r, wherein the first and second brake controllers are connected by a back-up connection 220 arranged to allow one of the first and the second brake controller to assume braking control of the wheel of the other of the first and the second brake controller, whereby the first and second brake controllers are arranged as fail-operational brake controllers. The braking system 500 further comprises a third brake controller WEM3′ arranged to control braking on a first rear axle 102 left wheel 140l, and a fifth brake controller WEM5′ arranged to control braking on a second rear axle 103 left wheel 160l, wherein the third and fifth brake controllers are connected by a back-up connection 220′ arranged to allow one of the third and the fifth brake controller to assume braking control of the wheel of the other of the third and the fifth brake controller, whereby the third and the fifth brake controllers are arranged as fail-operational brake controllers. FIG. 5B shows a brake controller layout 520 where rear axle WEMs are also arranged in fail-operational mode instead of fail-silent mode as in FIG. 4. This means that one rear axle WEM may assume control of the other rear axle WEM on the same rear axle. The front axle brake controller arrangement can be used together with the rear axle brake controller arrangement 520 shown in FIG. 5B. The two WEMs in FIG. 5B correspond in function to the WEMs exemplified in FIGS. 2 and 3.

It may be more critical to avoid uneven braking on the front axle, but it can still also be desirable to maintain braking on both wheels on the rear axle, e.g., to maximise deceleration.

Thus, FIG. 5B shows a rear axle part 520 of a braking system for a heavy duty vehicle 100. The braking system comprises a first brake controller WEM1 arranged to control braking on a front axle 101 left wheel 120l, and a second brake controller WEM2 arranged to control braking on a front axle 101 right wheel 120r, wherein the first and second brake controllers are connected by a back-up connection 220 arranged to allow one of the first and the second brake controller to assume braking control of the wheel of the other of the first and the second brake controller, whereby the first and second brake controllers are arranged as fail-operational brake controllers. The braking system 520 further comprises a third brake controller WEM3″ arranged to control braking on a first rear axle 102 left wheel 140l, and a fourth brake controller WEM4″ arranged to control braking on a first rear axle 102 right wheel 140r, wherein the third and fourth brake controllers are connected by a back-up connection 220″ arranged to allow one of the third and the fourth brake controller to assume braking control of the wheel of the other of the third and the fourth brake controller, whereby the third and the fourth brake controllers are arranged as fail-operational brake controllers.

FIG. 5B also shows an optional wheel speed sensor arrangement corresponding to that shown for the front axle wheels in FIG. 4. This arrangement has the same function as that in FIG. 4, i.e., there are optional redundant wheel speed sensors WS3b and WS4b, as well as optional cross-connections 540, 550.

FIG. 6 illustrates an example brake system 600 for controlling, e.g., a set of trailer wheels 180 supporting a trailer unit 102. Similar to the rear axle wheels 140, 160 in FIG. 4, the set of trailer wheels are arranged to be fail-silent. As one WEM fails, it will send a last message to the control unit 110 that it has zero braking capability. The control unit 110 may, as discussed above implement a polling function and/or a watchdog function in order to detect failed WEMs on the trailer unit 102. For instance, a WEM associated with a wheel in the set of trailer wheels 180 which is totally dead will not respond to polls at all, from which lack of response the control unit 110 can assume that the WEM has suffered failure and take appropriate action in response to the failure.

Note that the wheel speed sensors WS7-WS12 are not redundant per wheel, i.e., there is only one wheel speed sensor arranged per trailer wheel. However, the wheel speed sensors on each side are connected to all, or at least a subset of, WEMs. This connection arrangement provides a level of sensor redundancy, and allows the control unit 110 to access wheel speed data despite brake controller failure.

The fail-operational arrangements illustrated in FIG. 5A and in FIG. 5B may also be applied to the set of trailer wheels, but this arrangement may not be as advantageous as when applied at the tractor unit rear axle wheels. This is because a semitrailer has a long equivalent wheel base (the distance between the fifth wheel kingpin and the axle group). The wheel track width is only a fraction of the equivalent wheel base, so if for example a six wheeled semitrailer suffers a WEM outage, the loss in overall vehicle control capability is limited.

According to some aspects, as mentioned above, each wheel brake controller optionally has redundant power supplies and/or redundant pneumatic supplies. However, a more cost effective option could be that each wheel is only connected to one pneumatic and/or electrical supply, but where each WEM on, e.g., the front axle obtains its supplies from a different source. The front axle setup could be arranged such that: for instance, one air tank or pneumatic supply is connected to one of the front wheel's WEM and the other to the other supply. Then in the case where one tank loses pressure the main controller could request the side with no pressure supply to pass through the back-up connection 220 from the functioning side. Similarly if one electrical power supply is connected to one wheel's WEM and a separate supply is connected to the other then the main controller, then if power on one battery is lost one WEM will stay alive and control both front wheels. FIG. 7 illustrates some such optional aspects of the braking system 700 where the VMM 110 is connected to the left WEM 210l via the first communication bus 420, and connected to the right WEM 210r via the second communication bus 430. This means that the vehicle 100 may experience communication bus failure on one of the busses while still maintaining braking capability on both front wheels. This is made possible since communication is maintained to the functional WEM over the corresponding communication bus, and the functional WEM can control braking on the wheel of the failed WEM via the back-up connection 220.

FIG. 7 also illustrates aspects 700 where each front wheel WEM is powered by a separate electrical source 710, 720. Thus, if one WEM experiences electrical failure, such as power outage, then the other WEM will remain functional due to being powered from a different electrical power source.

FIG. 7 furthermore illustrates some further aspects where each front wheel WEM is supplied with air pressure from a separate pneumatic source 730, 740. Thus, if one WEM experiences pneumatic failure, such as an air tank failure or pneumatic hose leakage, then the other WEM will still remain functional due to being supplied from a different pneumatic source.

FIG. 8 illustrates aspects 800 corresponding to those in FIG. 7, but instead applied to the rear axle WEMs. Here, the first rear axle left wheel 140l is controlled by a WEM connected to the VMM or control unit 110 via the first communication bus 420, while the second rear axle left wheel 160l is controlled by a WEM connected to the VMM 110 via the second communication bus 430. Consequently, if one communication bus fails, some braking capability on the rear left side of the vehicle is maintained. A similar connection set-up is implemented on the rear axle right wheel WEMs.

FIG. 8 also shows aspects where separate electrical power sources 810, 820, and separate pneumatic supplies 830, 840, are used for the different left side rear axle wheels. This means that some braking capability is maintained on the rear left side of the vehicle despite electrical outage and/or pneumatic supply failure. A similar arrangement can be implemented on the rear right side of the vehicle.

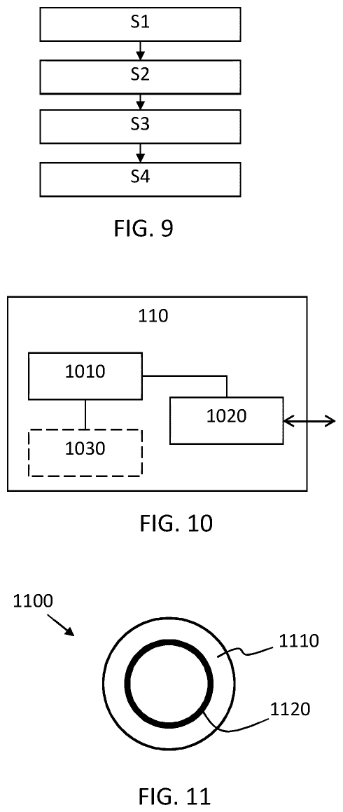

FIG. 9 is a flow chart illustrating a method for braking a heavy duty vehicle 100 that summarizes the discussions above. The method comprises configuring S1 a braking system comprising a first brake controller WEM1 arranged to control braking on a front axle 101 left wheel 120l, and a second brake controller WEM2 arranged to control braking on a front axle 101 right wheel 120r, wherein the first and second brake controllers are connected by a back-up connection 220 arranged to allow one of the first and the second brake controller to assume braking control of the wheel of the other of the first and the second brake controller.

The method also comprises configuring S2 a third brake controller WEM3 arranged to control braking on a first rear axle 102 left wheel 140l, and a fourth brake controller WEM4 arranged to control braking on a first rear axle 102 right wheel 140r, wherein the third WEM3 and the fourth WEM4 brake controllers are arranged to place respective rear axle left and right wheels in an unbraked state in response to failure, and, in response to the first or second brake controller failing; assuming S3 brake control of the wheel corresponding to the faulty brake controller by the other brake controller via the back-up connection 220, and, in response to the third or fourth brake controller failing; leaving S4 the corresponding rear wheel in an unbraked state.

With reference to FIG. 4 and FIG. 5A, there is also disclosed herein a method for braking a heavy duty vehicle 100. The method comprises configuring a braking system comprising a first brake controller WEM1 arranged to control braking on a front axle 101 left wheel 120l, and a second brake controller WEM2 arranged to control braking on a front axle 101 right wheel 120r, wherein the first and second brake controllers are connected by a back-up connection 220 arranged to allow one of the first and the second brake controller to assume braking control of the wheel of the other of the first and the second brake controller.

The method also comprises configuring a third brake controller WEM3′ arranged to control braking on a first rear axle 102 left wheel 140l, and a fifth brake controller WEM5′ arranged to control braking on a second rear axle 103 left wheel 160l, wherein the third WEM3′ and the fifth WEM5′ brake controllers are connected by a back-up connection 220′ arranged to allow one of the third and the fifth brake controller to assume braking control of the wheel of the other of the third and the fifth brake controller.

With reference to FIG. 4 and FIG. 5B, there is furthermore disclosed herein a method for braking a heavy duty vehicle 100. The method comprises configuring a braking system comprising a first brake controller WEM1 arranged to control braking on a front axle 101 left wheel 120l, and a second brake controller WEM2 arranged to control braking on a front axle 101 right wheel 120r, wherein the first and second brake controllers are connected by a back-up connection 220 arranged to allow one of the first and the second brake controller to assume braking control of the wheel of the other of the first and the second brake controller.

The method also comprises configuring a third brake controller WEM3″ arranged to control braking on a first rear axle 102 left wheel 140l, and a fourth brake controller WEM4″ arranged to control braking on a first rear axle 102 right wheel 140r, wherein the third WEM3″ and the fourth WEM4″ brake controllers are connected by a back-up connection 220″ arranged to allow one of the third and the fourth brake controller to assume braking control of the wheel of the other of the third and the fourth brake controller.

FIG. 10 schematically illustrates, in terms of a number of functional units, the components of a control unit 110 according to embodiments of the discussions herein. This control unit 110 may be comprised in the vehicle 100. Processing circuitry 1010 is provided using any combination of one or more of a suitable central processing unit CPU, multiprocessor, microcontroller, digital signal processor DSP, etc., capable of executing software instructions stored in a computer program product, e.g. in the form of a storage medium 1030. The processing circuitry 1010 may further be provided as at least one application specific integrated circuit ASIC, or field programmable gate array FPGA.

Particularly, the processing circuitry 1010 is configured to cause the control unit 110 to perform a set of operations, or steps, such as the methods discussed in connection to FIG. 10. For example, the storage medium 1030 may store the set of operations, and the processing circuitry 1010 may be configured to retrieve the set of operations from the storage medium 1030 to cause the control unit 110 to perform the set of operations. The set of operations may be provided as a set of executable instructions. Thus, the processing circuitry 1010 is thereby arranged to execute methods as herein disclosed.

The storage medium 1030 may also comprise persistent storage, which, for example, can be any single one or combination of magnetic memory, optical memory, solid state memory or even remotely mounted memory.

The control unit 110 may further comprise an interface 1020 for communications with at least one external device such as a suspension system sensor or IMU. As such the interface 1020 may comprise one or more transmitters and receivers, comprising analogue and digital components and a suitable number of ports for wireline or wireless communication. The processing circuitry 1010 controls the general operation of the control unit 110, e.g., by sending data and control signals to the interface 1020 and the storage medium 1030, by receiving data and reports from the interface 1020, and by retrieving data and instructions from the storage medium 1030. Other components, as well as the related functionality, of the control node are omitted in order not to obscure the concepts presented herein.

FIG. 11 illustrates a computer readable medium 1110 carrying a computer program comprising program code means 1120 for performing the methods illustrated in FIG. 9, when said program product is run on a computer. The computer readable medium and the code means may together form a computer program product 1100.

1. A braking system for a heavy duty vehicle, the braking system comprising a first brake controller arranged to control braking on a front axle left wheel, and a second brake controller arranged to control braking on a front axle right wheel, wherein the first and second brake controllers are connected by a back-up connection arranged to allow one of the first and the second brake controller to assume braking control of the wheel of the other of the first and the second brake controller, whereby the first and second brake controllers are arranged as fail-operational brake controllers, the braking system further comprising a third brake controller arranged to control braking on a first rear axle left wheel, and a fourth brake controller arranged to control braking on a first rear axle right wheel, wherein the third and the fourth brake controllers are arranged to place respective rear axle left and right wheels in an unbraked state in response to failure, whereby the third and fourth brake controllers are arranged as fail-silent brake controllers.

2. The braking system according to claim 1, further comprising a fifth brake controller arranged to control braking on a second rear axle left wheel, and a sixth brake controller arranged to control braking on a second rear axle right wheel, wherein the fifth and the sixth brake controllers are arranged to place respective second rear axle left and right wheels in an unbraked state in response to failure, whereby the fifth and sixth brake controllers are arranged as fail-silent brake controllers.

3. The braking system according to claim 1, comprising a control unit arranged to control the braking system via at least a first data bus and a second data bus separate from the first data bus, wherein the first data bus is arranged to control at least the first brake controller and the fourth brake controller, and the second data bus is arranged to control at least the second brake controller and the third brake controller.

4. The braking system according to any previous claim 1, wherein, a failing rear axle wheel brake controller arranged as a fail-silent brake controller is configured to transmit a message to a vehicle control unit indicating a lack of braking capability.

5. The braking system according to claim 4, wherein the failing rear axle wheel brake controller arranged as fail-silent brake controller is configured to be locked in a zero braking capability mode upon failure and until restart of the brake controller.

6. The braking system according to claim 4, wherein each rear axle wheel brake controller comprises a respective back-up electrical energy source arranged to allow transmission of the message to the vehicle control unit in the event of failure.

7. The braking system according to claim 1, wherein each front axle wheel brake controller is connected to a respective first wheel speed sensor and to a respective second wheel speed sensor, thereby providing wheel speed sensor redundancy at the front axle.

8. The braking system according to claim 1, wherein a wheel speed sensor associated with a wheel on the front axle is arranged connected to a brake controller associated with a wheel on the other side of the front axle.

9. The braking system according to claim 1, wherein the vehicle comprises first and second rear wheel axles, wherein a wheel speed sensor associated with a wheel on the first rear axle is arranged connected to a brake controller associated with a wheel on the second rear wheel axle and on the same side as the wheel on the first rear axle.

10. The braking system according to claim 9, wherein a rear axle wheel brake controller is arranged to detect wheel lift-off by comparing wheel speed sensor output from respective first rear axle wheel speed sensor and second rear axle wheel speed sensor.

11. The braking system according to claim 1, wherein the vehicle comprises a trailer unit supported on a set of trailer wheels, wherein at least one of the wheels in the set of wheels comprises a brake controller arranged in fail silent mode.

12. The braking system according to claim 1, wherein the control unit 110 is arranged to re-allocate braking force in response to brake controller failure.

13. The braking system according to claim 1, wherein the control unit 110 is arranged to re-evaluate vehicle stability in response to brake controller failure.

14. A braking system for a heavy duty vehicle, the braking system comprising a first brake controller arranged to control braking on a front axle left wheel, and a second brake controller arranged to control braking on a front axle right wheel, wherein the first and second brake controllers are connected by a back-up connection arranged to allow one of the first and the second brake controller to assume braking control of the wheel of the other of the first and the second brake controller, whereby the first and second brake controllers are arranged as fail-operational brake controllers, the braking system further comprising a third brake controller arranged to control braking on a first rear axle left wheel, and a fifth brake controller arranged to control braking on a second rear axle left wheel, wherein the third and fifth brake controllers are connected by a back-up connection arranged to allow one of the third and the fifth brake controller to assume braking control of the wheel of the other of the third and the fifth brake controller, whereby the third and the fifth brake controllers are arranged as fail-operational brake controllers.

15. A braking system for a heavy duty vehicle, the braking system comprising a first brake controller arranged to control braking on a front axle left wheel, and a second brake controller arranged to control braking on a front axle right wheel, wherein the first and second brake controllers are connected by a back-up connection arranged to allow one of the first and the second brake controller to assume braking control of the wheel of the other of the first and the second brake controller, whereby the first and second brake controllers are arranged as fail-operational brake controllers, the braking system further comprising a third brake controller arranged to control braking on a first rear axle left wheel, and a fourth brake controller arranged to control braking on a first rear axle right wheel, wherein the third and fourth brake controllers are connected by a back-up connection arranged to allow one of the third and the fourth brake controller to assume braking control of the wheel of the other of the third and the fourth brake controller, whereby the third and the fourth brake controllers are arranged as fail-operational brake controllers.

16. A vehicle comprising the braking system according to claim 1.

17. A method for braking a heavy duty vehicle, the method comprising; configuring a braking system comprising a first brake controller arranged to control braking on a front axle left wheel, and a second brake controller arranged to control braking on a front axle right wheel, wherein the first and second brake controllers are connected by a back-up connection arranged to allow one of the first and the second brake controller to assume braking control of the wheel of the other of the first and the second brake controller, and
configuring a third brake controller arranged to control braking on a first rear axle left wheel, and a fourth brake controller arranged to control braking on a first rear axle right wheel, wherein the third and the fourth brake controllers are arranged to place respective rear axle left and right wheels in an unbraked state in response to failure,
and, in response to the first or second brake controller failing;
assuming brake control of the wheel corresponding to the faulty brake controller by the other brake controller via the back-up connection,
and, in response to the third or fourth brake controller failing;
leaving the corresponding rear wheel in an unbraked state.

18. A computer program comprising program code means for performing the steps of claim 17 when said program is run on a computer or on processing circuitry of a control unit.

19. A computer readable medium carrying a computer program comprising program code means for performing the steps of claim 17 when said program product is run on a computer or on processing circuitry of a control unit.
